(19) United States
(12) Patent Application Publication
(10) Pub. No.: US 2023/0044498 A1
(43) Pub. Date: Feb. 9, 2023

(54) FLAME RETARDANT AND THERMALLY STABILIZED POLYETHERIMIDES

(71) Applicant: SHPP GLOBAL TECHNOLOGIES B.V., Bergen op Zoom (NL)

(72) Inventors: Mark A. SANNER, Mt. Vernon, IN (US); Raghavendra Raj MADDIKERI, Mt. Vernon, IN (US); Thomas Link GUGGENHEIM, Mount Vernon, IN (US); Manojkumar CHELLAMUTHU, Mount Vernon, IN (US)

(21) Appl. No.: 17/783,507

(22) PCT Filed: Dec. 30, 2020
(86) PCT No.: PCT/US2020/067486

§ 371 Date: Jun. 8, 2022

(30) Foreign Application Priority Data
Dec. 31, 2019 (EP) 19220229.9

(51) Int. Cl. C08G 73/10; C08K 5/526

(52) U.S. Cl. CPC C08G 73/1046; C08K 5/526; C08K 2201/019

(57) ABSTRACT

A polyetherimide composition comprises: a polyetherimide; and an organophosphorus stabilizer present in an amount effective to provide greater than 0.01 ppm to less than 20 ppm, preferably greater than 0.01 ppm to less than 10 ppm, and more preferably greater than 0.01 ppm to less than 4.8 ppm of phosphorus based on the total weight of the polyetherimide composition, the organophosphorus stabilizer having a molecular weight of 300 to 2,000 Daltons and a phosphorus content of 1 to 15 wt %; wherein a molded sample of the polyetherimide composition has a UL 94 V0 rating at a thickness of 1.5 mm.

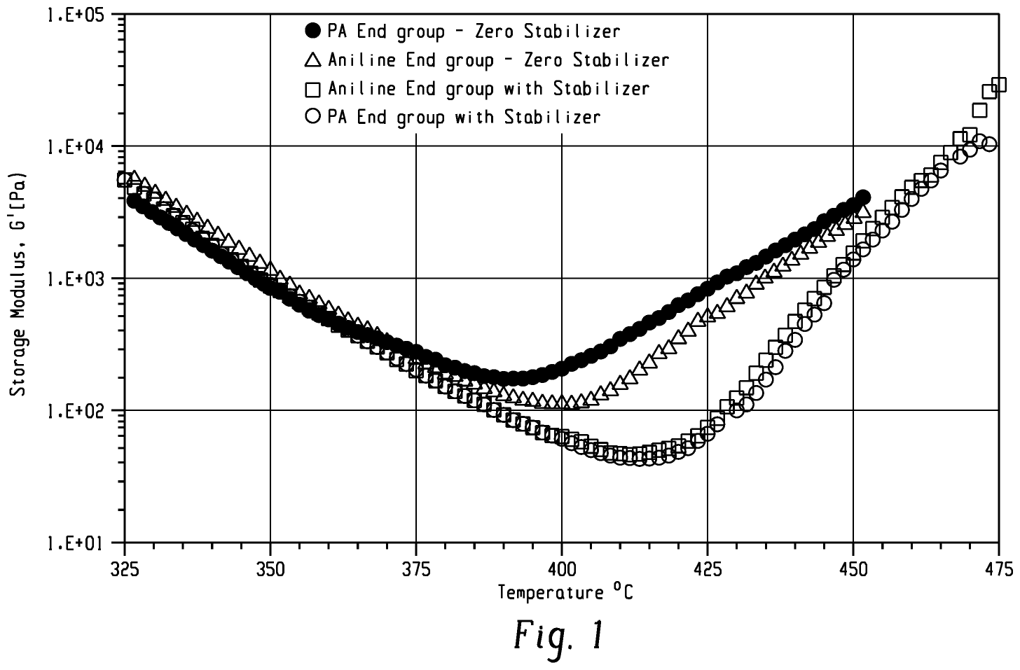

### CROSS REFERENCE TO RELATED APPLICATIONS

This application claims the benefit of EP Application No. 19220229.9, filed on Dec. 31, 2019, which is incorporated herein by reference in its entirety.

### BACKGROUND

Polyetherimides are amorphous, transparent high performance polymers having a glass transition temperature (Tg) of greater than 180° C. These polymers further have high strength, heat resistance, and modulus, and broad chemical resistance. Polyetherimides are widely used in applications as diverse as automotive, telecommunication, aerospace, electrical/electronics, transportation, and healthcare. Due to their broad use, particularly in the electrical and consumer electronics applications, there is a continuing need for polyetherimide compositions that meet a flammability rating of V-0 in the 1.5 millimeter Vertical Burning Flame Test of Underwriter's Laboratory Bulletin 94 “Tests for Flammability of Plastic Materials, UL 94” which are often required for these applications.

Polyetherimides are inherently flame retardant. However, certain additives that are used to adjust other properties of polyetherimides can affect and result in inconsistent results in UL 94 flame testing. Accordingly, polyetherimide compositions having robust UL 94 V0-rating at 1.5 mm sample thickness are continuously sought.

### SUMMARY

A polyetherimide composition comprises: a polyetherimide; and an organophosphorus stabilizer present in an amount effective to provide greater than 0.01 ppm to less than 20 ppm, preferably greater than 0.01 ppm to less than 10 ppm, and more preferably greater than 0.01 ppm to less than 4.8 ppm of phosphorus based on the total weight of the polyetherimide composition, the organophosphorus stabilizer having a molecular weight of 300 to 2,000 Daltons and a phosphorus content of 1 to 15 wt %; wherein a molded sample of the polyetherimide composition has a UL 94 V0 rating at a thickness of 1.5 mm.

Also disclosed is a thermoplastic composition comprising the above-referenced polyetherimide composition.

### BRIEF DESCRIPTION OF THE DRAWINGS

A description of the FIGURE, which are meant to be exemplary and not limiting, is provided in which:

The FIGURE is a graph depicting storage modulus (Pa·s) of various polyetherimide compositions as a function of temperature T (° C.).

The above described and other features are exemplified by the following Detailed Description and Examples.

### DETAILED DESCRIPTION

Heat stabilizers can be added during the production of polyetherimides to improve the melt stability and heat resistance of polyetherimides. Heat stabilizers can also help minimize a change in yellowness index during secondary melt processing operations such as injection molding, extrusion, and the like. However, the inventors hereof have found that higher amounts of stabilizers, especially when used in lower molecular weight polyetherimides, can increase the probability of dripping of the polyetherimides during UL flame testing, leading to inconsistent testing results. The inventors have further discovered that if used in amounts of greater than zero but less than 100 ppm, organophosphorus stabilizers do not adversely affect the UL-94 V0 performance of polyetherimides. Thus, polyetherimide compositions having improved melt stability and robust UL-94 V0 performance at the same time can be provided.

As used herein, the organophosphorus stabilizers can be an organophosphite, an organophosphonite, an organophosphinite, or a combination comprising at least one of the foregoing. The organophosphorus stabilizers can have a molecular weight of 300 to 2,000 grams/mole (Daltons or Da) or 500 to 1,500 Da with a phosphorus content of 1 to 12 wt % or 3 to 10 wt %.

Specific organophosphorus stabilizers are represented by formula (1), (2), or (3):

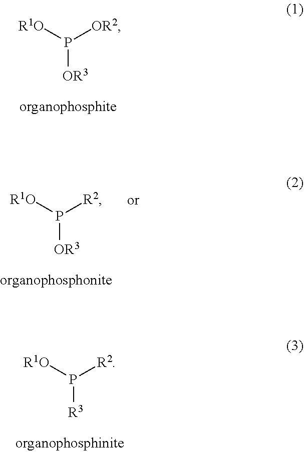

In formulas (1)-(3), each of R¹, R², and R³ is independently a substituted or unsubstituted C₁₋₄₀ alkyl, or a substituted or unsubstituted C₆₋₃₀ aryl, with the proviso that optionally at least two of R¹, R², and R³ taken together form a substituted or unsubstituted fused heteroaliphatic ring. Substituents for the alkyl group include an N-containing moiety, halogen, a substituted or unsubstituted aryl, an ether moiety, an ester moiety, a phosphite-containing moiety, a phosphonite-containing moiety, or a combination comprising at least one of the foregoing. Substituents for the aryl group include a C₁₋₄₀ alkyl, an N-containing moiety, halogen, a phosphite-containing moiety, a phosphonite-containing moiety, or a combination comprising at least one of the foregoing.

When the organophosphorus stabilizers are organophosphites, each of R¹, R², and R³ can be a substituted C₁₀₋₃₀ aryl such as C₁₀₋₃₀ alkylarylene, preferably each of R¹, R², and R³ is a C₁₂₋₃₀ alkylarylene.

The organophosphorus stabilizers can also be organophosphites of formula (4):

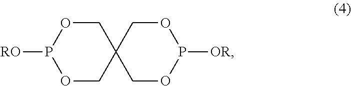

wherein R is a substituted or unsubstituted C₆₋₃₀ aryl, preferably a substituted C₁₀₋₃₀ aryl.

In an aspect, the organophosphorus stabilizers comprise tris(2,4-di-tert-butylphenyl) phosphite (IRGAFOS 168), tris-(nonylphenyl)phosphite (TNPP), tetrakis(2,4-di-tert-butylphenyl) [1,1′-biphenyl]-4,4′-diylbis(phosphonite) (PEPQ), bis(2,4-dicumylphenyl)pentaerythritol diphosphite, tris(nonylphenyl)phosphite (DOVERPHOS S-9228), bis(2,4-di-tert-butylphenyl) pentraerythritol diphosphite (ULTRANOX 626), 2,2′,2″-nitrilo[triethyl-tris[3,3′,5,5′-tetra-tert-butyl-1,1′-biphenyl-2,2′diyl]] phosphite (IRGAPHOS 12), or a combination comprising at least one of the foregoing, and preferably the organophosphorus stabilizers comprise tris(2,4-di-tert-butylphenyl) phosphite.

Structures of specific organophosphorus stabilizers are shown in formulas (5)-(10):

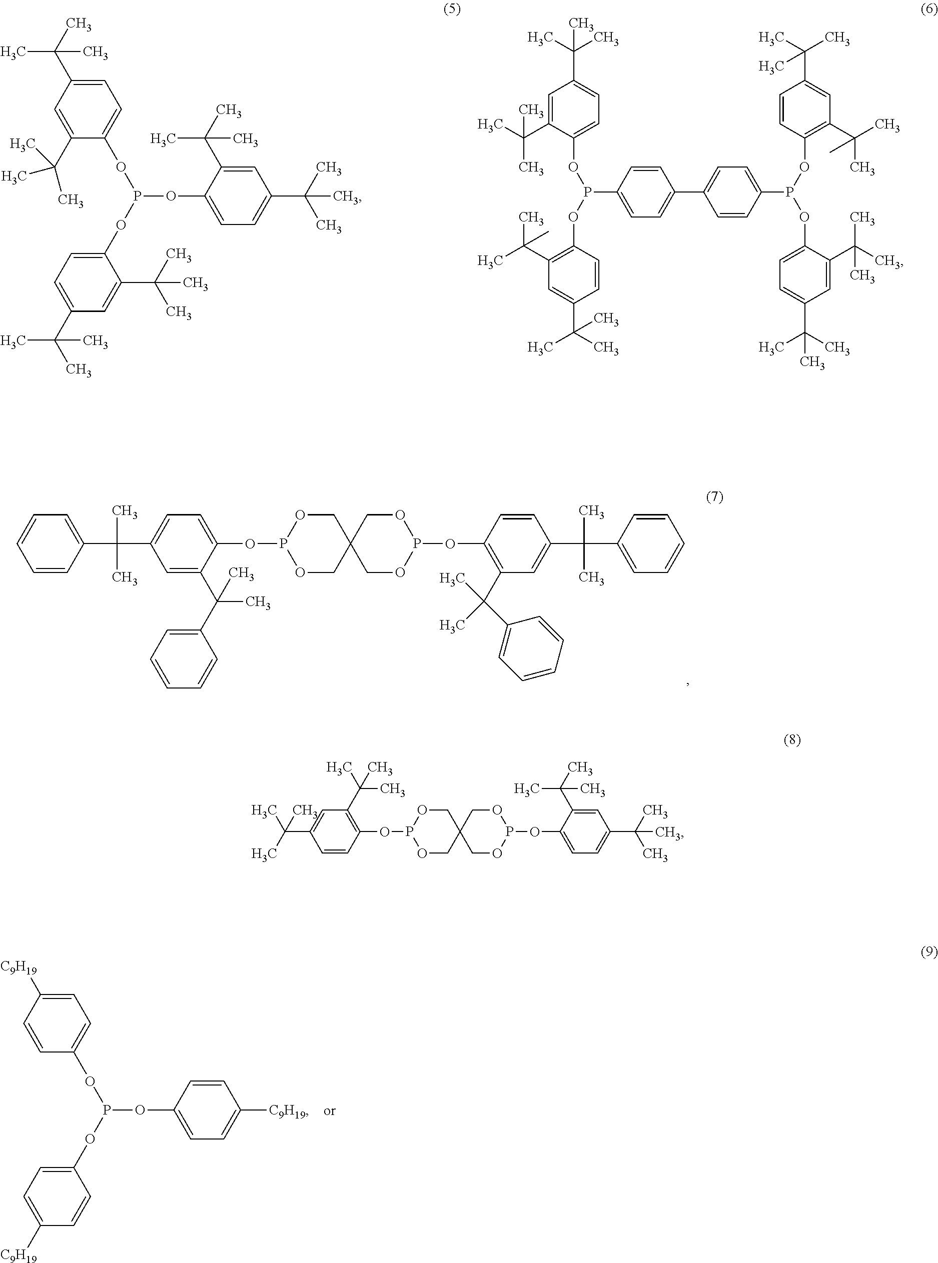

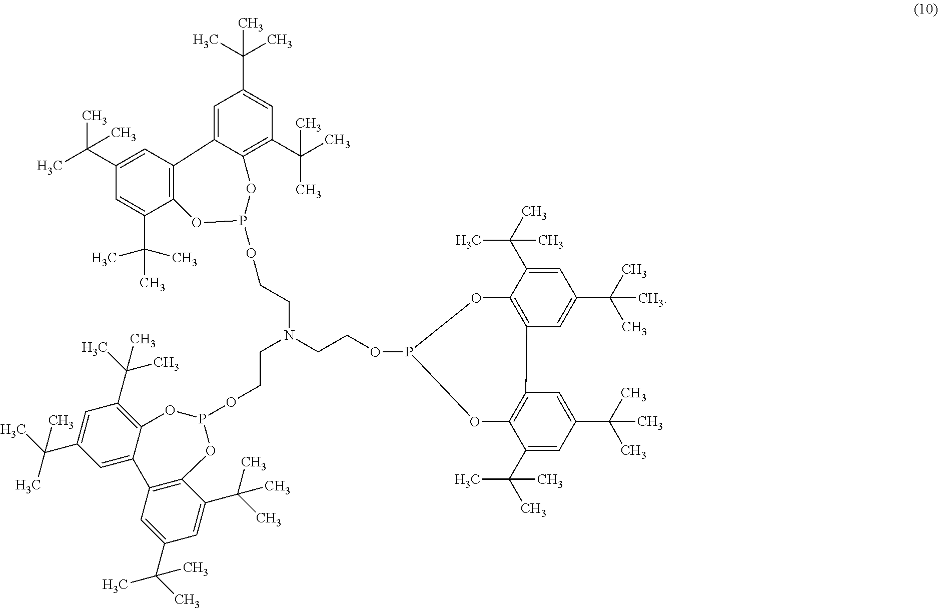 [SMILES: CC(C)(C)c1cc(C(C)(C)C)c2op(OCCN(CCOp3oc4c(C(C)(C)C)cc(C(C)(C)C)cc4c4cc(C(C)(C)C)cc(C(C)(C)C)c4o3)CCOp3oc4c(C(C)(C)C)cc(C(C)(C)C)cc4c4cc(C(C)(C)C)cc(C(C)(C)C)c4o3)oc3c(C(C)(C)C)cc(C(C)(C)C)cc3c2c1]

Optionally, the organophosphorus stabilizers can be used together with hindered phenolic thermal stabilizers. The hindered phenolic thermal stabilizers can have a molecular weight of greater than 300 Da to less than 2,000 Da. In such embodiment, the molecular weight of the hindered phenolic thermal stabilizer can help retain the hindered phenol moiety in a polymer melt at high processing temperatures, such as for example a temperature of equal to or greater than 200° C. The number of hydroxyl groups in the hindered phenolic thermal stabilizers can be 2 to 6 or 2 to 4 per molecule of the hindered phenols. In some embodiments the polyetherimide composition may be free of hindered phenolic thermal stabilizers.

Examples of hindered phenolic thermal stabilizers include (oxalylbis(azanediyl))bis(ethane-2,1-diyl) bis(3-(3,5-di-tert-butyl-4-hydroxyphenyl)propanoate) (NAUGARD XL-1), 1,3,5-trimethyl-2,4,6-tris(3,5-di-tert-butyl-4-hydroxybenzyl)benzene (IRGANOX 1330), pentaerythritol tetrakis(3-(3,5-di-tert-butyl-4-hydroxyphenyl)propionate) (IRGANOX F174), N,N′-1,6-hexanediylbis[3,5-bis(1,1-dimethylethyl)-4-hydroxyphenylpropanamide] (IRGANOX 1098), 1,3,5-tris(4-tert-butyl-3-hydroxy-2,6-dimethyl benzyl)-1,3,5-triazine-2,4,6-(1H,3H,5H)-trion (CYANOX 1790), 2′,3-bis[[3-[3,5-di-tert-butyl-4-hydroxyphenyl]propionyl]]proponiohydrazine (IRGANOX MD 1024), a butylated reaction product of p-cresol and dicyclopentadiene (WINGSTAY L), or a combination comprising at least one of the foregoing.

Structures of specific hindered phenolic thermal stabilizers are represented by formula (11)-(17):

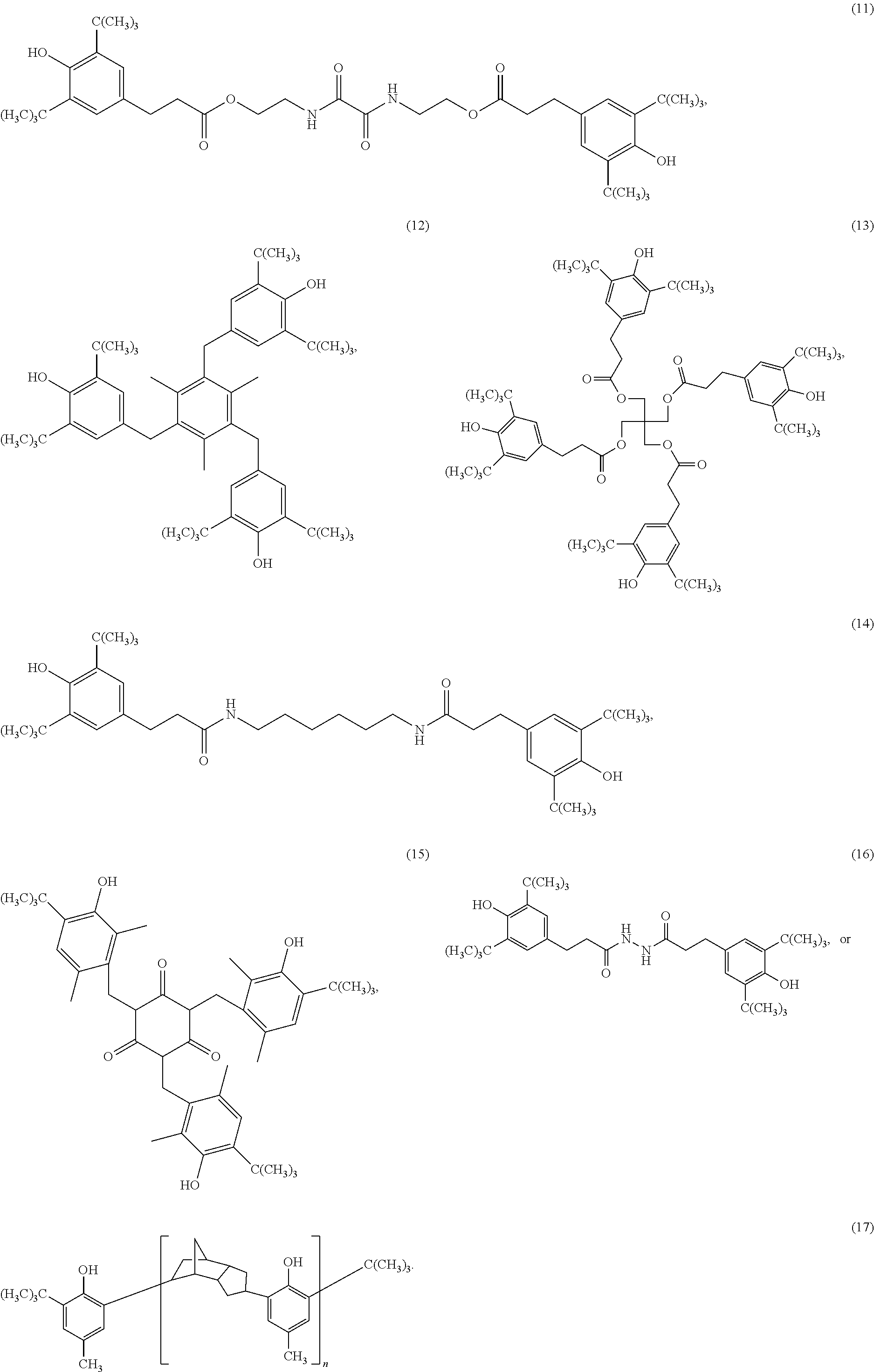

As used herein, polyetherimides or poly(etherimide)s mean homopolymers or copolymers comprising more than 1, for example 2 to 1000, or 5 to 500, or 10 to 100 structural units of formula (18)

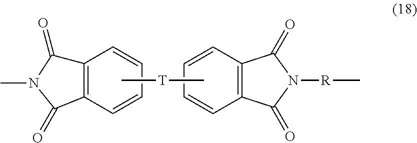

wherein each R is independently the same or different, and is a substituted or unsubstituted divalent organic group, such as a substituted or unsubstituted C₆₋₂₀ aromatic hydrocarbon group, a substituted or unsubstituted straight or branched chain C₄₋₂₀ alkylene group, a substituted or unsubstituted C₃₋₈ cycloalkylene group, in particular a halogenated derivative of any of the foregoing. In some embodiments R is divalent group of one or more of the following formulas (19)

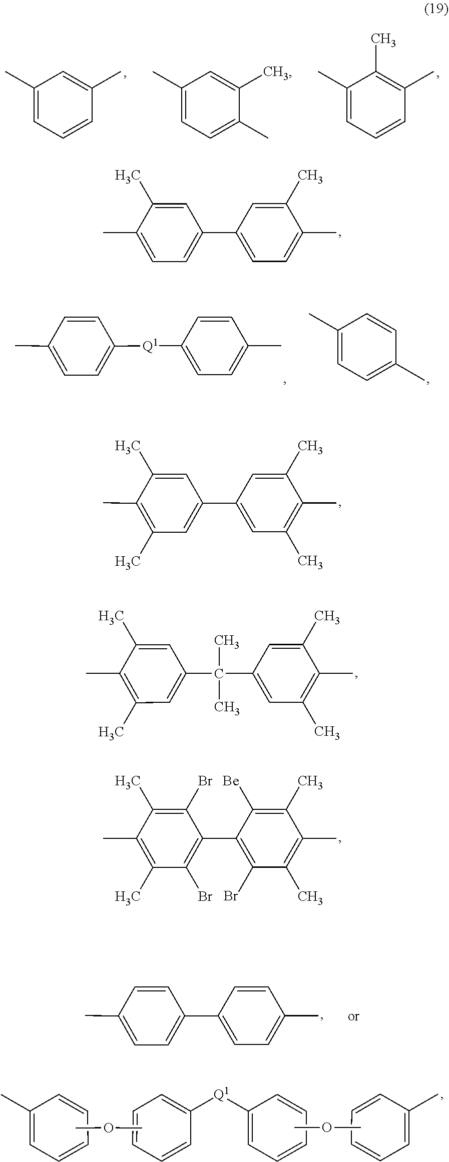

wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H₂₇— wherein y is an integer from 1 to 5 or a halogenated derivative thereof (which includes perfluoroalkylene groups), or —(C₆H₁₀)_{z}— wherein z is an integer from 1 to 4. In some embodiments R is m-phenylene, p-phenylene, or a diarylene sulfone, in particular bis(4,4′-phenylene)sulfone, bis(3,4′-phenylene)sulfone, bis(3,3′-phenylene)sulfone, or a combination comprising at least one of the foregoing. In some embodiments, at least 10 mole percent or at least 50 mole percent of the R groups contain sulfone groups such as in particular bis(4,4′-phenylene)sulfone, bis(3,4′-phenylene)sulfone, bis(3,3′-phenylene)sulfone, with the remainder of the R groups, if present, being is m-phenylene or p-phenylene. In some embodiments none of the R groups include a sulfone group. In some embodiments R is m-phenylene, p-phenylene, or a combination thereof.

Further in formula (18), T is —O— or a group of the formula —O—Z—O— wherein the divalent bonds of the —O— or the —O—Z—O— group are in the 3,3′, 3,4′, 4,3′, or the 4,4′ positions of the aromatic ring bearing the imide moiety, and Z is an aromatic C₆₋₂₄ monocyclic or polycyclic moiety optionally substituted with 1 to 6 C₁₋₈ alkyl groups, 1 to 8 halogen atoms, or a combination comprising at least one of the foregoing, provided that the valence of Z is not exceeded. Exemplary groups Z include groups of formula (20)

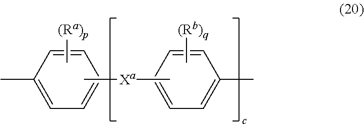

wherein R^{a} and R^{b} are each independently the same or different, and are a halogen atom, or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (20a)

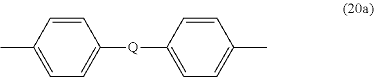

wherein Q is —O—, —S—, —C(O)—, —SO₂—, —SO—, —P(R^{a})(═O)— wherein R^{a} is a C₁₋₁₈ alkyl or C₆₋₁₂ aryl, or —C_{y}H_{2y}— wherein y is an integer from 1 to 5 or a halogenated derivative thereof (including a perfluoroalkylene group). In a specific embodiment Z is a derived from bisphenol A, such that Q in formula (20a) is 2,2-isopropylidene.

In an embodiment in formula (18), R is m-phenylene, p-phenylene, or a combination comprising at least one of the foregoing, and T is —O—Z—O— wherein Z is a divalent group of formula (20a). Alternatively, R is m-phenylene, p-phenylene, or a combination comprising at least one of the foregoing, and T is —O—Z—O wherein Z is a divalent group of formula (20a) and Q is 2,2-isopropylidene.

In another embodiment, the poly(etherimide)s are poly(etherimide) sulfones having more than 1, for example 2 to 1000, or 5 to 500, or 10 to 100 structural units of formula (18), wherein at least 10 mole percent or at least 50 mole percent of the R groups contain sulfone groups. In an embodiment, at least 10 mole percent or at least 50 mole percent of the R groups contain sulfone groups in particular bis(4,4′-phenylene)sulfone, bis(3,4′-phenylene)sulfone, bis(3,3′-phenylene)sulfone, or a combination comprising at least one of the foregoing, with the remainder of the R groups, if present, being is m-phenylene or p-phenylene. T is as defined herein, and preferably T is —O—Z—O—, wherein Z is a divalent group of formula (20a), for example, 2,2-(4-phenylene)isopropylidene, i.e., a bisphenol A moiety.

The poly(etherimide)s can be prepared by any of the methods known to those skilled in the art, including the reaction of an aromatic bis(ether anhydride) of formula (21) or a chemical equivalent thereof, with an organic diamine of formula (22)

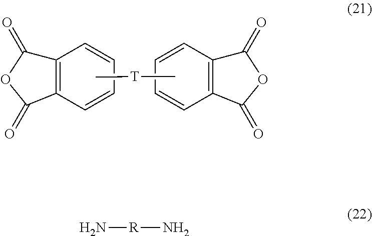

wherein T and R are defined as described above. Copolymers of the poly(etherimide)s can be manufactured using a combination of an aromatic bis(ether anhydride) of formula (21) and an additional bis(anhydride) that is not a bis(ether anhydride), for example pyromellitic dianhydride or bis(3,4-dicarboxyphenyl) sulfone dianhydride. Organophosphorus stabilizers can be added during the process of manufacturing the poly(etherimide)s.

Illustrative examples of aromatic bis(ether anhydride)s include 2,2-bis[4-(3,4-dicarboxyphenoxy)phenyl]propane dianhydride (also known as bisphenol A dianhydride or BPADA), 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride; 4,4′-(hexafluoroisopropylidene)diphthalic anhydride; and 4-(2,3-dicarboxyphenoxy)-4′-(3,4-dicarboxyphenoxy)diphenyl sulfone dianhydride. A combination of different aromatic bis(ether anhydride)s can be used.

Examples of organic diamines include 1,6-hexanediamine, 1,7-heptanediamine, 1,8-octanediamine, 1,9-nonanediamine, 1,10-decanediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2, 2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1, 3-diamino-4-isopropylbenzene, bis(4-aminophenyl) sulfide, bis-(4-aminophenyl) sulfone (also known as 4,4′-diaminodiphenyl sulfone (DDS)), and bis(4-aminophenyl) ether. Any regioisomer of the foregoing compounds can be used. C₁_₄ alkylated or poly(C₁₋₄)alkylated derivatives of any of the foregoing can be used, for example a polymethylated 1,6-hexanediamine. Combinations of these compounds can also be used. In some embodiments the organic diamine is m-phenylenediamine, p-phenylenediamine, 4,4′-diaminodiphenyl sulfone, 3,4′-diaminodiphenyl sulfone, 3,3′-diaminodiphenyl sulfone, or a combination comprising at least one of the foregoing.

The poly(etherimide)s can have a hydroxyl end group content of less than 1,000 ppm, less than 500 ppm, or less than 100 ppm by weight of the poly(etherimide)s.

The poly(etherimide)s can have a melt index of 0.5 to 2.3 grams per minute (g/min), as measured by American Society for Testing Materials (ASTM) D1238 at 337° C., using a 6.7 kilogram (kg) weight. Preferably, the poly(etherimide)s have a melt index of 1.5 to 2.3 g/min or 1.7 to 2.1 g/min, more preferably 1.7 to 2.0 g/min or 1.8 to 2.0 g/min, as measured by ASTM D1238 at 337° C., using a 6.7 kg weight.

The poly(etherimide)s have a weight average molecular weight (Mw) of 1,000 to 50,000 grams/mole (Dalton), as measured by gel permeation chromatography (GC), using polystyrene standards. Preferably, the poly(etherimide)s have an Mw of 10,000 to 50,000 Daltons, 40,000 to 50,000 Daltons, or 46,000 to 48,000 Daltons, as measured by gel permeation chromatography, using polystyrene standards. The poly(etherimide)s can be endcapped with an endcapping agent such as phthalic anhydride or aniline.

Preferably, the poly(etherimide)s have a glass transition temperature (Tg) of 130 to 320° C., preferably 210 to 320° C., more preferably 215 to 312° C., determined by differential scanning calorimetry (DSC) as per ASTM D3418 with a 20° C./min heating rate. Examples of poly(etherimide)s having such glass transition temperatures include poly(etherimide) sulfones as described herein.

The organophosphorus stabilizers can be present in an amount effective to provide greater than 0.01 ppm to less than 20 ppm, preferably greater than 0.01 ppm to less than 10 ppm, and more preferably greater than 0.01 ppm to less than 4.8 ppm of phosphorus based on the total weight of the polyetherimide compositions. In an aspect, the organophosphorus stabilizers are present in an amount effective to provide greater than 0.04 ppm to less than 20 ppm, preferably greater than 0.04 ppm to less than 10 ppm, and more preferably greater than 0.04 ppm to less than 4.8 ppm of phosphorus based on the total weight of the polyetherimide compositions. The amount of the stabilizer is determined by gas chromatography (GC) or a high performance liquid chromatography (HPLC) depending on the specific organophosphorus stabilizer used. When the stabilizer is tris(2,4-di-tert-butylphenyl) phosphite, gas chromatography is used to determine the amount of the stabilizer. As the stabilizer may decompose, evaporate, or otherwise be consumed during the process of making the polyetherimide compositions, the initial amount of the organophosphorus compound used to make the polyetherimide compositions can be higher than 100 ppm, for example 200 to 5000 ppm.

When the organophosphorus stabilizer is tris(2,4-di-tert-butylphenyl) phosphite, the polyetherimide compositions can have a phosphorous content of greater than 0.01 ppm to less than 4.8 ppm or greater than 0.04 ppm to less than 4.8 ppm by weight based on the total weight of the polyetherimide compositions. For other organophosphorus stabilizers, the phosphorus content can be less than 20 ppm, less than 10 ppm, or less than 4.8 ppm, but greater than 0.01 ppm or greater than 0.04 ppm by weight based on the total weight of the polyetherimide compositions.

The polyetherimides can be present in an amount of greater than greater than 98 wt %, preferably greater than 99 wt % based on the total weight of the polyetherimide compositions. In addition to the organophosphorus stabilizers and the optional hindered phenolic stabilizers, the polyetherimide compositions can also contain additives such as mold releasing agents. The polyetherimide compositions may be free of other thermoplastic polymers. For example, the polyetherimide composition may be free of thermoplastic polymers such as polyesters, polycarbonates or both.

The polyetherimide compositions can be essentially free of certain metals or metal ions. In an embodiment, the polyetherimide compositions contain less than 20 ppm or less than 10 ppm by weight of each of metals or ions of Na, Fe, Co, Ni, Mo, Ca, and Mg. The polyetherimide compositions can also contain less than 20 ppm or less than 10 ppm by weight of transition metals or ions thereof such as Cr, Mn, Ti, and Zn.

The polyetherimide compositions have good flame retardant properties. A molded sample of the polyetherimide compositions has a UL 94 V0 rating at a thickness of 1.5 mm. In addition, a molded sample of the composition can have a probability of first time pass of the UL94 V0 test of at least 0.9 at a thickness of 1.5 mm, preferably a molded sample of the composition has a probability of first time pass of the UL94 V0 test of at least 0.95 at a thickness of 1.5 mm.

The polyetherimide compositions are thermally stabilized and can also have excellent resistance to thermal degradation.

The polyetherimide compositions can have a yellowness index of less than 100, less than 90, or less than 80 measured in accordance with ASTM D1925 using a 3.2 mm thick injection molded specimen/part.

The polyetherimide compositions have a storage modulus of equal to or greater than 65 Pa, for example 65 to 200 Pa, determined according to ASTM D4440-15 at 23° C. on extruded pellets of the polyetherimide compositions.

The polyetherimide compositions can be present in the form of pellets or powder (fines).

The polyetherimide compositions can be formulated with various additives to provide thermoplastic compositions, with the proviso that the additives are selected so as to not significantly adversely affect the desired properties of the composition. Exemplary additives include catalysts, impact modifiers, fillers, antioxidants, light stabilizers, ultraviolet light (UV) absorbing additives, quenchers, plasticizers, lubricants, mold release agents, antistatic agents, visual effect additives such as dyes, pigments, and light effect additives, flame retardants, anti-drip agents, and radiation stabilizers. The foregoing additives (except any fillers) are generally present in an amount from 0.005 to 20 wt. %, specifically 0.01 to 10 wt. %, based on the total weight of the thermoplastic compositions.

In some embodiments, the thermoplastic compositions can further include at least one additional polymer. Examples of such additional polymers include and are not limited to PPSU (polyphenylene sulfone), polyetherimides, PSU (polysulfone), PPE (polyphenylene ether), PFA (perfluoroalkoxy alkane), MFA (co-polymer of TFE tetrafluoroethylene and PFVE perfluorinated vinyl ether), FEP (fluorinated ethylene propylene polymers), PPS (poly(phenylene sulfide), PTFE (polytetrafluoroethylene), PA (polyamide), PBI (polybenzimidizole), PAI (poly(amide-imide)), poly(ether sulfone), poly(aryl sulfone), polyphenylene, polybenzoxazoles, polybenzthiazoles, as well as blends and co-polymers thereof. When present, the polymer is used in an amount from more than 0 to 20 wt. %, specifically 0.1 to 15 wt. %, and more specifically from 0.5 to 10 wt. %, all based on the total weight of the polyetherimide composition. In some embodiments, no polymer other than the polyetherimide as described herein is present in the thermoplastic composition. In some embodiments, no polyester or polycarbonate is present in the polyetherimide composition.

The polyetherimide and thermoplastic compositions can be formed into an article by any number of methods including shaping, extruding (including profile extrusion), thermoforming, and molding, including injection molding, compression molding, gas assist molding, structural foam molding, and blow molding. In some embodiments, a method of forming an article comprises shaping, extruding, blow molding, or injection molding the polyetherimide or thermoplastic compositions to form the article. The polyetherimide and thermoplastic compositions can also be formed into articles using thermoplastic processes such as film extrusion, sheet extrusion, melt casting, blown film extrusion, and calendaring. Co-extrusion and lamination processes can be used to form composite multi-layer films or sheets.

The article is a sheet, film, multilayer sheet, multilayer film, molded part, extruded profile, coated part, pellets, powder, foam, fiber, fibrids, flaked fibers, or a combination comprising at least one of the foregoing.

The above described and other features are exemplified by the following examples. In the examples, unless otherwise specified, the percent (%) of the components is weight percent based on the total weight of the composition.

### EXAMPLES

### Materials

Various batches of polyetherimides were made by polymerizing 2,2-bis[4-(3,4-dicarboxyphenoxy)phenyl]propane dianhydride and meta-phenylene diamine using phthalic anhydride or aniline as the endcapping agent. An organophosphorus stabilizer, namely, tris(2,4-di-tert-butylphenyl) phosphite, was added during the process of making the polyetherimides.

### Sample Testing

Melt index was measured in accordance with ASTM D1238 at 337° C., using a 6.7 kilogram (kg) weight.

Yellowness index (YI) was measured in accordance with ASTM D1925 using a 3.2 mm thick injection molded specimen/part.

The amount of the stabilizer in the samples was determined by gas chromatography.

The storage modulus was determined using a dynamic oscillatory temperature sweep method (Melt Rheology). The experiments were run using an ARES strain controlled rheometer. The temperature sweep method was used to determine the viscosity or modulus of the material as a function of temperature. The temperature was varied from 300 to 480° C. with a heating rate of 10° C./min.

Storage modulus was determined according to IS06721-10 and ASTM D4440-01. Dynamic Mechanical Analysis (Melt Rheology) was performed on pellets or injection molded specimen/part.

The storage modulus of polyetherimides decreases initially as a function of temperature and upon reaching a transition temperature (onset temperature of thermal decomposition and crosslinking) the storage modulus increases significantly. The onset temperature of storage modulus change, Tₒₙₛₑₜ, was obtained by conducting a temperature sweep of 10° C./min under air atmosphere in the rheometer

Flammability tests were performed following the procedure of Underwriter's Laboratory Bulletin 94 entitled “Tests for Flammability of Plastic Materials for Parts in Devices and Appliances” (ISBN 0-7629-0082-2), Fifth Edition, Dated Oct. 29, 1996, incorporating revisions through and including Dec. 12, 2003. Several ratings can be applied based on the rate of burning, time to extinguish, ability to resist dripping, and whether or not drips are observed or ignite the cotton. According to this procedure, materials can be classified as UL94 HB, V0, V1, V2, 5VA, or 5VB at a given sample thickness. The test specimens were aged at 23° C., 50% RH for 48 hours before testing.

Data was collected from many samples (typically 20 bars), then analyzed by calculating the average flame out time (FOT), standard deviation of the flame out time, and the total number of drips (#Drips), and by using statistical methods to convert that data to a prediction of the probability of first time pass, or “p(FTP)”, that a particular sample formulation would achieve a “pass” rating in the conventional UL94 V0 testing of 5 bars. P(FTP) will be as close to 1 as possible, for example greater than 0.9 and more preferably greater than 0.95, for maximum flame-retardant performance in UL testing. A 90% probability of passing the first time (i.e., p(FTP) of 0.9) is considered acceptable performance. Values that are significantly lower than 0.9 are considered unacceptable.

### Examples 1-15

Exemplary polyetherimide compositions of the disclosure (Ex 1 to Ex 11), along with control or comparative compositions (CEx12 to CEx 15), were tested for melt flow index, yellowness index, stabilizer content, storage modulus, onset temperature (temperature at which modulus increases due to crosslinking with concomitant Mw build of the polyetherimide polymer), and flame retardant properties. The results are shown in Table 1. The compositions contain tris(2,4-di-tert-butylphenyl) phosphite (stabilizer) in amounts as indicated in Table 1, and a phthalic anhydride endcapped polyetherimide having a weight average molecular weight of 46,000 to 48,000 Daltons as determined by GPC using polystyrene standards.

TABLE 1

| | | Ex | Ex | Ex | Ex | Ex | Ex | Ex | Ex | Ex | Ex | Ex | CEx | CEx | CEx | CEx |
|---|---|---|---|---|---|---|---|---|---|---|---|---|---|---|---|---|
| | Unit | 1 | 2 | 3 | 4 | 5 | 6 | 7 | 8 | 9 | 10 | 11 | 12 | 13 | 14 | 15 |
| Melt Index | g/min | 1.8 | 1.7 | 1.8 | 1.6 | 1.7 | 2 | 1.6 | 2 | 1.7 | 1.8 | 1.9 | 1.8 | 1.7 | 1.6 | 1.6 |
| YI | | 79 | 80 | 79 | 77 | 78 | 78 | 77 | 75 | 76 | 75 | 74 | 71 | 72 | 72 | 74 |
| Stabilizer | ppm | 1 | 2 | 12 | 16 | 23 | 26 | 37 | 46 | 49 | 69 | 82 | 109 | 123 | 138 | 600 |
| P (FTP) | % | 0.99 | 0.99 | 0.99 | 0.98 | 0.99 | 0.96 | 0.98 | 0.99 | 0.99 | 0.99 | 0.98 | 0.57 | 0.35 | 0.17 | 0.13 |
| #Drips | | 0 | 0 | 0 | 0 | 0 | 1 | 0 | 0 | 0 | 0 | 0 | 7 | 8 | 16 | 16 |
| (n = 20) | | | | | | | | | | | | | | | | |
| #FOT > 10 s | | 0 | 0 | 0 | 1 | 0 | 2 | 0 | 0 | 1 | 1 | 0 | 2 | 3 | 3 | 4 |
| Onset Temp. | ° C. | 390 | 395 | — | — | 400 | — | | — | | 405 | 405 | — | 410 | 410 | 420 |
| Storage | Pa | 170 | 120 | — | — | 98 | — | — | — | — | 67 | 65 | — | 56 | 45 | 45 |
| Modulus at | | | | | | | | | | | | | | | | |
| 425° C. | | | | | | | | | | | | | | | | |

The data shows the effects of the amount of organophosphorus stabilizers on the flame retardant performance of polyetherimide compositions. When the amount of the organophosphorus stabilizer is less than 100 ppm, the polyetherimide compositions (Ex 1-Ex 12) all have a probability of first time pass of the UL 94 V0 test of at least 0.9 at a sample thickness of 1.5 mm. In contrast, when the amount of the organophosphorus stabilizer is greater than 100 ppm, the polyetherimide compositions (CEx 13-CEx 15) have a probability of first time pass of less than 0.6.

During the UL-94 V0 flame testing, upon exposure to the flame, the flame bar heats beyond the glass transition temperature (Tg) of the material, and the material can melt, elongate, and finally drip. Without wishing to be bound by theory, it is believed that the probability of dripping is reduced if the polyetherimide has higher zero shear viscosity or melt strength, or if the polyetherimide undergoes cross-linking due to thermal degradation.

An earlier onset temperature indicates that the polyetherimide is less thermally stable, thus more likely to crosslink at lower temperatures, and hence has reduced probability to drip. As shown in Table 1, the onset temperature of the compositions that had a pFTP of >0.95 is 405° C. or lower, and the onset temperature of the compositions that had a pFTP<0.9 is 410° C. or higher.

Storage modulus as measured by dynamic oscillatory temperature sweep method at a specific temperature, for example 150 degrees above glass transition temperature is related to the flame retardance performance of the compositions. As shown in Table 1, the storage modulus of the compositions of the disclosure is equal to or greater than 65 Pa while the storage modulus of the comparative compositions is equal to or less than 56 Pa. Thus, the onset temperature and storage modulus at a specific temperature, for example 425° C., can be used as a screening tool to predict the flame retardance performance of polyetherimide compositions.

### Examples 16-19

Temperature sweep studies were conducted for polyetherimides endcapped with phthalic anhydride or aniline, stabilized with 110 to 140 ppm of tris(2,4-di-tert-butylphenyl) phosphite or unstabilized. The temperature sweep curves are shown in the FIGURE. As shown in the FIGURE, there is no major difference in the rheological behavior/dripping behavior of polyetherimides with different end-groups.

### Comparative Examples 20 and 21

Various polyetherimides having a weight average molecular weight of 53,000 to 56,000 Daltons, as measured by gel permeation chromatography, using polystyrene standards were made by polymerizing 2,2-bis[4-(3,4-dicarboxyphenoxy)phenyl]propane dianhydride and meta-phenylene diamine using phthalic anhydride or aniline as the endcapping agent. An organophosphorus stabilizer, namely, tris(2,4-di-tert-butylphenyl) phosphite, was added during the process of making the polyetherimides. One set of the compositions contained the stabilizer in an amount of greater than 0 to less than 100 ppm, and another set of the compositions contained the stabilizer in an amount of greater than 100 ppm but less than 200 ppm. Flame retardant properties of the compositions were evaluated. The results show that the compositions robustly pass the UL 94 V0 rating at a sample thickness of 1.5 mm, regardless how much stabilizer was used. In other words, the results suggest that when the weight average molecular weight of the polyetherimide is greater than 50,000 Daltons as measured by GPC using polystyrene standards, the amount of the organophosphorus stabilizer no longer affects the flame retardant performance of the polyetherimide.

Set forth below are various aspects of the disclosure.

Aspect 1. A polyetherimide composition comprising: a polyetherimide; and an organophosphorus stabilizer present in an amount effective to provide greater than 0.01 ppm to less than 20 ppm, preferably greater than 0.01 ppm to less than 10 ppm, and more preferably greater than 0.01 ppm to less than 4.8 ppm of phosphorus based on the total weight of the polyetherimide composition, the organophosphorus stabilizer having a molecular weight of 300 to 2,000 Daltons and a phosphorus content of 1 to 15 wt %; wherein a molded sample of the polyetherimide composition has a UL 94 V0 rating at a thickness of 1.5 mm.

Aspect 2. The polyetherimide composition of Aspect 1, wherein a molded sample of the polyetherimide composition has a probability of first time pass of the UL94 V0 test of at least 0.9 at a thickness of 1.5 mm, preferably a molded sample of the polyetherimide composition has a probability of first time pass of the UL94 V0 test of at least 0.95 at a thickness of 1.5 mm.

Aspect 3. The polyetherimide composition of any one or more of Aspects 1 to 2, wherein the organophosphorus stabilizer is present in an amount effective to provide greater than 0.04 ppm to less than 20 ppm, preferably greater than 0.04 ppm to less than 10 ppm, and more preferably greater than 0.04 ppm to less than 4.8 ppm of phosphorus based on the total weight of the polyetherimide composition.

Aspect 4. The polyetherimide composition of any one of Aspects 1 to 3, wherein the organophosphorus stabilizer has the formula

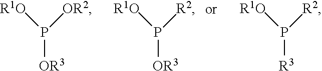

wherein each of R¹, R², and R³ is independently a substituted or unsubstituted C₁₋₄₀ alkyl, or a substituted or unsubstituted C₆₋₃₀ aryl, with the proviso that optionally at least two of R¹, R², and R³ taken together form a substituted or unsubstituted fused heteroaliphatic ring.

Aspect 5. The polyetherimide composition of any one or more of Aspects 1 to 4, wherein the organophosphorus stabilizer comprises tris(2,4-di-tert-butylphenyl) phosphite, tris-(nonylphenyl)phosphite, tetrakis(2,4-di-tert-butylphenyl) [1,1′-biphenyl]-4,4′-diylbis(phosphonite), bis(2,4-dicumylphenyl)pentaerythritol diphosphite, tris(nonylphenyl)phosphite, bis(2,4-di-tert-butylphenyl) pentraerythritol diphosphite, 2,2′,2″nitrilo[triethyl-tris[3,3′,5,5′-tetra-ter-butyl-1,1′-biphenyl-2,2′diyl]] phosphite, or a combination comprising at least one of the foregoing, and preferably the organophosphorus stabilizer comprises tris(2,4-di-tert-butylphenyl).

Aspect 6. The polyetherimide composition of any one or more of Aspects 1 to 5, wherein the polyetherimide has a weight average molecular weight of 1,000 Daltons to 50,000 Daltons, preferably 40,000 Daltons to 50,000 Daltons, more preferably 46,000 Daltons to 48,000 Daltons, as measured by gel permeation chromatography, using polystyrene standards.

Aspect 7. The polyetherimide composition of any one or more of Aspects 1 to 6, wherein the polyetherimide has a melt index of 0.5 to 2.3 grams per minute, preferably 1.5 to 2.3 grams per minute, as measured by ASTM D1238 at 337° C., using a 6.7 kilogram weight.

Aspect 8. The polyetherimide composition of any one or more of Aspects 1 to 7, wherein the poly(etherimide) comprises structural units of the formula:

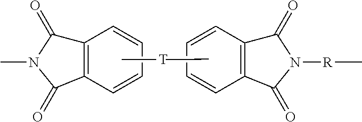

wherein each R is independently a substituted or unsubstituted divalent organic group; and T is —O— or a group of the formula —O—Z—O— wherein the divalent bonds of the —O— or the —O—Z—O— group are in the 3,3′, 3,4′, 4,3′, or the 4,4′ positions, and Z is an aromatic C₆₋₂₄ monocyclic or polycyclic moiety optionally substituted with 1 to 6 C₁₋₈ alkyl groups, 1 to 8 halogen atoms, or a combination comprising at least one of the foregoing.

Aspect 9. The polyetherimide composition of any one or more of Aspects 1 to 8, wherein R is a divalent group of one or more of the following formulas

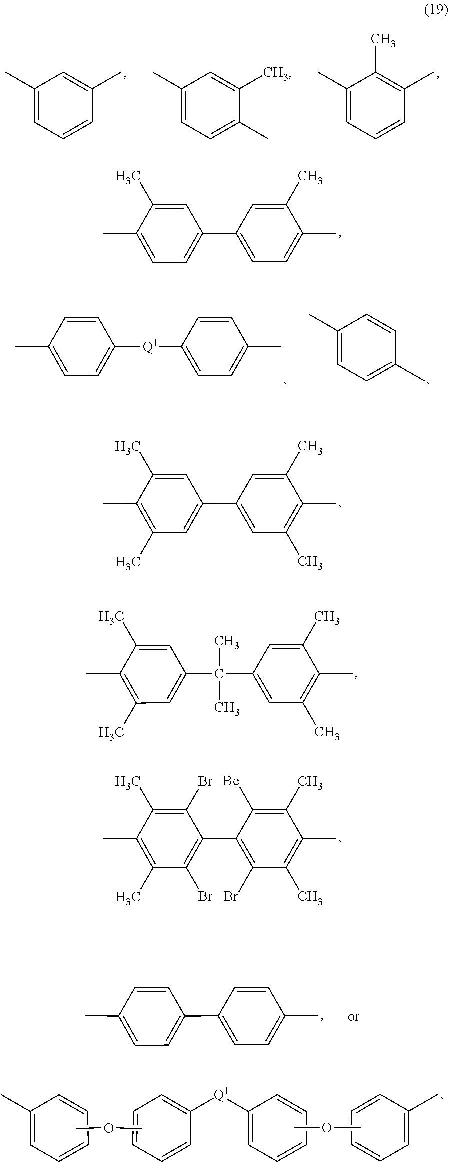

wherein Q¹ is —O—, —S—, —C(O)—, —SO₂—, —SO—, —P(R^{a})(═O)— wherein R^{a} is a C₁-8 alkyl or C₆₋₁₂ aryl, —C_{y}H_{2y}— wherein y is an integer from 1 to 5 or a halogenated derivative thereof, or —(C₆H₁₀)_{z}— wherein z is an integer from 1 to 4, preferably m-phenylene, p-phenylene, or a diarylene sulfone; and Z is 2,2-(4-phenylene)isopropylidene.

Aspect 10. The polyetherimide composition of any one or more of Aspects 1 to 9, wherein the polyetherimide has a hydroxyl end group content of less than 1,000 ppm, preferably less than 500 ppm, more preferably less than 100 ppm.

Aspect 11. The polyetherimide composition of any one or more of Aspects 1 to 10, further comprising a hinder phenolic thermal stabilizer having a molecular weight of 400 to 2,000 Daltons.

Aspect 12. The polyetherimide composition of any one or more of Aspects 1 to 11, wherein the polyetherimide is present in an amount of greater than 98 wt % or greater than 99 wt % based on the total weight of the composition.

Aspect 13. The polyetherimide composition of any one or more of Aspects 1 to 12, wherein the polyetherimide is present in an amount of greater than 98 wt %, preferably greater than 99 wt % based on the total weight of the composition and comprises structural units of the formula:

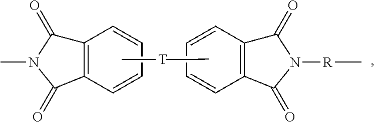

wherein R is m-phenylene, T is the —O—Z—O— group, and Z is 2,2-(4-phenylene)isopropylidene, the polyetherimide is endcapped with phthalic anhydride or aniline and has a weight average molecular weight of 40,000 Daltons to 50,000 Daltons, as measured by gel permeation chromatography, using polystyrene standards; and the organophosphorus stabilizer comprises tris(2,4-di-tert-butylphenyl) phosphite, tetrakis(2,4-di-tert-butylphenyl) [1,1′-biphenyl]-4,4′-diylbis(phosphonite), bis(2,4-dicumylphenyl)pentaerythritol diphosphite, tris(nonylphenyl)phosphite, or a combination thereof, and preferably the organophosphorus stabilizer comprises tris(2,4-di-tert-butylphenyl) phosphite and is present in an amount effective to provide greater than 0.04 ppm to less than 4.8 ppm of phosphorus based on the total weight of the polyetherimide composition.

Aspect 14. The polyetherimide composition of any one or more of Aspects 1 to 13, wherein no polyester or polycarbonate is present in the polyetherimide composition.

Aspect 15. The polyetherimide composition of any one or more of Aspects 1 to 14, wherein the composition is free of hindered phenolic thermal stabilizers.

Aspect 16. A thermoplastic composition comprising the polyetherimide composition of any one or more of Aspects 1 to 15.

Aspect 17. An article comprising the polyetherimide composition of any one or more of Aspects 1 to 15 or a thermoplastic composition of Aspect 16.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl” and “hydrocarbon” refers broadly to a substituent comprising carbon and hydrogen, optionally with 1 to 3 heteroatoms, for example, oxygen, nitrogen, halogen, silicon, sulfur, or a combination thereof; “alkyl” refers to a straight or branched chain, saturated monovalent hydrocarbon group; “alkylene” refers to a straight or branched chain, saturated, divalent hydrocarbon group; “aryl” refers to an aromatic monovalent group containing only carbon in the aromatic ring or rings; “arylene” refers to an aromatic divalent group containing only carbon in the aromatic ring or rings; “alkylarylene” refers to an aryl group that has been substituted with an alkyl group as defined above, with 4-methylphenyl being an exemplary alkylarylene group; “arylalkylene” refers to an alkyl group that has been substituted with an aryl group as defined above, with benzyl being an exemplary arylalkylene group.

Unless otherwise indicated, each of the foregoing groups can be unsubstituted or substituted, provided that the substitution does not significantly adversely affect synthesis, stability, or use of the compound. The term “substituted” as used herein means that at least one hydrogen on the designated atom or group is replaced with another group, provided that the designated atom's normal valence is not exceeded. When the substituent is oxo (i.e., ═O), then two hydrogens on the atom are replaced. Combinations of substituents and/or variables are permissible provided that the substitutions do not significantly adversely affect synthesis or use of the compound. Groups that can be present on a substituted position include (—NO₂), cyano (—CN), halogen, thiocyano (—SCN), C₂-6 alkanoyl (e.g., acyl (H₃CC(═O)—); carboxamido; C₁₋₆ or C₁₋₃ alkyl, cycloalkyl, alkenyl, and alkynyl; C₁-6 or C₁₋₃ alkoxy; C₆₋₁₀ aryloxy such as phenoxy; C₁₋₆ alkylthio; C₁₋₆ or C₁₋₃ alkylsulfinyl; C₁₋₆ or C₁₋₃ alkylsulfonyl; C₆₋₁₂ aryl having at least one aromatic rings (e.g., phenyl, biphenyl, naphthyl, or the like, each ring either substituted or unsubstituted aromatic); C₇₋₁₉ arylalkylene having 1 to 3 separate or fused rings and 6 to 18 ring carbon atoms; or arylalkoxy having 1 to 3 separate or fused rings and 6 to 18 ring carbon atoms. The stated number of carbon atoms includes any substituents.

All references cited herein are incorporated by reference in their entirety. While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein. Use of the word “comprising” allows for the inclusion of other components but also describes situations in which other components are not present and the composition consists essentially of or consists of the recited components.

1. A polyetherimide composition comprising:
a polyetherimide; and
an organophosphorus stabilizer present in an amount effective to provide greater than 0.01 ppm of phosphorus based on the total weight of the polyetherimide composition, the organophosphorus stabilizer having a molecular weight of 300 to 2,000 Daltons and a phosphorus content of 1 to 15 wt %;
wherein a molded sample of the polyetherimide composition has a UL 94 V0 rating at a thickness of 1.5 mm.

2. The polyetherimide composition of claim 1, wherein a molded sample of the polyetherimide composition has a probability of first time pass of the UL94 V0 test of at least 0.9 at a thickness of 1.5 mm.

3. The polyetherimide composition of claim 1, wherein the organophosphorus stabilizer is present in an amount effective to provide greater than 0.04 ppm to less than 20 ppm of phosphorus based on the total weight of the polyetherimide composition.

4. The polyetherimide composition of claim 1, wherein the organophosphorus stabilizer has the formula 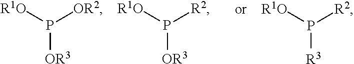
wherein each of R¹, R², and R³ is independently a substituted or unsubstituted C₁₋₄₀ alkyl, or a substituted or unsubstituted C₆₋₃₀ aryl, with the proviso that optionally at least two of R¹, R², and R³ taken together form a substituted or unsubstituted fused heteroaliphatic ring.

5. The polyetherimide composition of claim 1, wherein the organophosphorus stabilizer comprises tris(2,4-di-tert-butylphenyl) phosphite, tris-(nonylphenyl)phosphite, tetrakis(2,4-di-tert-butylphenyl) [1,1′-biphenyl]-4,4′-diylbis(phosphonite), bis(2,4-dicumylphenyl)pentaerythritol diphosphite, tris(nonylphenyl)phosphite, bis(2,4-di-tert-butylphenyl) pentraerythritol diphosphite, 2,2′,2″-nitrilo[triethyl-tris[3,3′,5,5′-tetra-tert-butyl-1,1′-biphenyl-2,2′-diyl]] phosphite, or a combination comprising at least one of the foregoing.

6. The polyetherimide composition of claim 1, wherein the polyetherimide has a weight average molecular weight of 1,000 Daltons to 50,000 Daltons, as measured by gel permeation chromatography, using polystyrene standards.

7. The polyetherimide composition of claim 1, wherein the polyetherimide has a melt index of 0.5 to 2.3 grams per minute, as measured by ASTM D1238 at 337° C., using a 6.7 kilogram weight.

8. The polyetherimide composition of claim 1, wherein the poly(etherimide) comprises structural units of the formula: 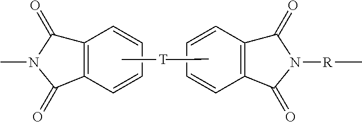
wherein
each R is independently a substituted or unsubstituted divalent organic group; and
T is —O— or a group of the formula —O—Z—O— wherein the divalent bonds of the —O— or the —O—Z—O— group are in the 3,3′, 3,4′, 4,3′, or the 4,4′ positions, and Z is an aromatic C₆₋₂₄ monocyclic or polycyclic moiety optionally substituted with 1 to 6 C₁₋₈ alkyl groups, 1 to 8 halogen atoms, or a combination comprising at least one of the foregoing.

9. The polyetherimide composition of claim 1, wherein
R is a divalent group of one or more of the following formulas 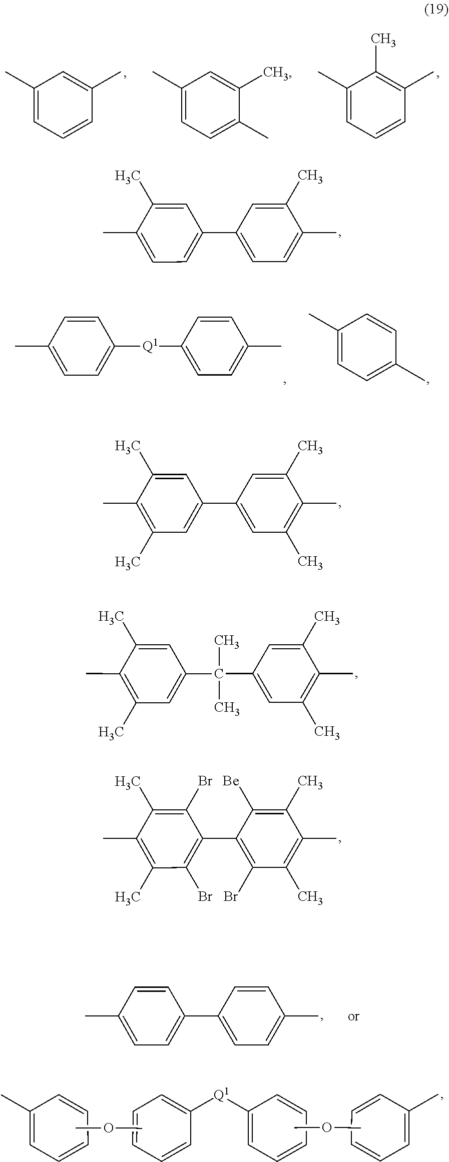
wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof, or —(C₆H₁₀)_{z}— wherein z is an integer from 1 to 4, preferably m-phenylene, p-phenylene, or a diarylene sulfone; and
Z is 2,2-(4-phenylene)isopropylidene.

10. The polyetherimide composition of claim 1, wherein the polyetherimide has a hydroxyl end group content of less than 1,000 ppm.

11. The polyetherimide composition of claim 1, further comprising a hinder phenolic thermal stabilizer having a molecular weight of 400 to 2,000 Daltons.

12. The polyetherimide composition of claim 1, wherein the polyetherimide is present in an amount of greater than 98 wt % based on the total weight of the composition.

13. The polyetherimide composition of claim 1, wherein the polyetherimide is present in an amount of greater than 98 wt % based on the total weight of the composition and comprises structural units of the formula: 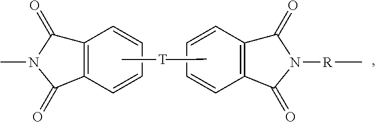
wherein R is m-phenylene, T is the —O—Z—O— group, and Z is 2,2-(4-phenylene)isopropylidene,
the polyetherimide is endcapped with phthalic anhydride or aniline and has a weight average molecular weight of 40,000 Daltons to 50,000 Daltons, as measured by gel permeation chromatography, using polystyrene standards; and
the organophosphorus stabilizer comprises tris(2,4-di-tert-butylphenyl) phosphite, tetrakis(2,4-di-tert-butylphenyl) [1,1′-biphenyl]-4,4′-diylbis(phosphonite), bis(2,4-dicumylphenyl)pentaerythritol diphosphite, tris(nonylphenyl)phosphite, or a combination thereof and is present in an amount effective to provide greater than 0.04 ppm to less than 4.8 ppm of phosphorus based on the total weight of the polyetherimide composition.

14. The polyetherimide composition of claim 1, wherein no polyester or polycarbonate is present in the polyetherimide composition.

15. The polyetherimide composition of claim 1 wherein the composition is free of hindered phenolic thermal stabilizers.

16. A thermoplastic composition comprising the polyetherimide composition of claim 1.

17. An article comprising the polyetherimide composition of claim 1.
